(19) United States
(12) Patent Application Publication
(10) Pub. No.: US 2005/0186237 A1
(43) Pub. Date: Aug. 25, 2005

(54) Bird repellent

(76) Inventors: Tim Day, Hamilton (NZ); Lindsay Ross Matthews, Hamilton (NZ)

Correspondence Address: KNOBBE MARTENS OLSON & BEAR LLP, 2040 MAIN STREET, FOURTEENTH FLOOR, IRVINE, CA, 92614, US

(21) Appl. No.: 11/016,569

(22) Filed: Dec. 17, 2004

Related U.S. Application Data
(63) Continuation of application No. PCT/NZ03/00127, filed on Jun. 20, 2003.

(30) Foreign Application Priority Data
Jun. 20, 2002 (NZ) 519685

(51) Int. Cl. A01N 25/00

(52) U.S. Cl. 424/405

(57) ABSTRACT

A bird repellent composition containing a combination of anthraquinone and a visual cue; or anthraquinone and d-pulegone; or anthraquinone, a visual cue and d-pulegone is disclosed. The combinations have been found to produce a synergistic and unexpected effect of increased repellence to birds. One application is the area of pest control baits where the repellent composition is applied to the surface of the bait. Birds are less likely to be harmed by the toxins contained within the bait because they are repelled from the bait. A second application is for horticulture use, whereby the repellent composition is applied to the plant, fruit or ground around an orchard or vineyard thus repelling birds.

### RELATED APPLICATIONS

The present application is a continuation of, and claims priority under 35 U.S.C. § 120 to PCT Application No. PCT/NZ03/00127 filed on Jun. 20, 2003 and published in English as WO 2004/000014 Al on Dec. 31, 2003, titled “A Bird Repellent,” which claims priority to New Zealand Patent Application No. 519685, filed on Jun. 20, 2002, titled “A Bird Repellent,” each of which is incorporated herein by reference in its entirety.

### TECHNICAL FIELD

The present invention relates to an animal repellent mixture. More specifically it relates to a bird repellent mixture.

### BACKGROUND OF THE INVENTION

Poisonous baits are widely used in New Zealand to kill introduced mammalian pests. Effective pest control operations have conservation benefits, including recovery of bird populations such as the North Island robin Petroica australis longipes (Powlesland et al., 1999) and North Island kokako Callaeas cinera (Innes et al. 1999). It is generally assumed that the benefits of pest control outweigh the risks to non-target species (Spurr, 1991).

Poison-based possum control causes some mortality of non-target species native bird species (Spurr, 2000). Ground feeding birds, such as the robin, are particularly vulnerable to poisoning (Brown, 1997; Powlesland et al. 1999; Empson and Miskelly, 1999). While there is currently no evidence of long-term adverse impacts of poisoning on populations of non-target species that have been adequately monitored, non-target mortality is a significant factor reducing the acceptability of pest poisoning operations to the public (Fitzgerald et al. 2000). Further, the possibility remains that there may be adverse effects on species that have not yet been assessed. By reducing non-target bird mortality during pest control, populations may recover more quickly and successfully and pest control practices may be considered to be more ethically sound.

Two main bait manipulations are currently used to deter birds from eating toxic substances (as specified in the New Zealand Pesticides Act 1979): (1) all baits must be larger than 16 mm, so birds cannot readily manipulate them; and (2) all baits must be dyed green, a color believed to be unattractive to birds (Caithness and Williams, 1971). Additionally, cinnamon oil is frequently added to bait as a further bird deterrent compound. Unfortunately, native birds still die during pest control operations that use large green dyed, cinnamon flavored baits (Spurr, 2000). Therefore, baits or bait additives are required that effectively repel non-target birds while remaining attractive to pest species such as brushtail possums Trichosurus vulpecula and rats Rattus spp.

Potential methods for reducing bait acceptability to birds include the use of less preferred bait types (e.g. gel; Morgan, 1999), less preferred bait colors (e.g. blue; Hartley et al, 1999,2000), or bird repellent compounds (e.g. cinnamamide; Spurr and Porter, 1998). Each of these has its limitations. While gel baits appear to be unattractive to native birds (Morgan, 1999), to date they have not been used to control pests over the very large areas that can be effectively controlled with aerially sown baits. Additionally, some bait types (e.g. cereal) may pose greater risk to birds if the baits break up into edible sized pieces when birds feed on them. Blue dye is less attractive to native birds than green (Hartley et al 1999, 2000), and is accepted by pests (Day and Matthews, 1999), but is not a long lasting deterrent. Chemical repellents that have been tested to date are either too costly or have deleterious effects on bait consumption by target pests (e.g. cinnamamide; Spurr and Porter, 1998; Spurr et al 2001).

Repellents may be classified as either primary or secondary (Rogers, 1978). Primary repellents invoke instantaneous rejection responses through sight, taste, smell and/or irritation and do not require learning to be effective (Clark, 1998). They are often more benign, and are less effective at promoting long-lasting avoidance responses than secondary repellent (Domjan, 1998). Secondary repellents act via an illness-induced learned avoidance of the food. The degree of avoidance depends on the strength of the unpleasant experience. However, potent secondary repellents often have undesirable physiological and metabolic consequences (Sayre and Clark, 2001), and it may not be desirable to expose valued native species to such effects.

Combinations of repellent stimuli can be more effective for deterring birds than single repellents. Several researchers have found that methiocarb (a secondary repellent) is more effective when paired with either another chemical or a visual cue (e.g. Mason and Reidinger, 1983). Also, secondary repellents are effective at much lower concentrations when paired with aversive primary repellents, such as tastes, odors or colors (Avery and Nelms, 1990; Avery and Mason, 1997; Nelms and Avery, 1997).

d-Pulegone (CAS No.89-82-7) is a volatile compound (a type of peppermint) and acts as a primary repellent for birds via both volatile cues (odor) and by direct contact (taste) (Wager-Page and Mason, 1996). It has been shown to repel several bird species at a 1% w/w concentration, including European starlings Sturnus vulgaris (Mason, 1990) and northern bobwhites Colinus virginianus (Mastrota and Mench, 1995). As d-pulegone repels birds without them having to ingest the food, the compound may be ideal for prevention of intake of poisonous baits. However, primary repellents often do not promote total or long lasting avoidance responses when they are used alone (Domjan, 1998). Wild brushtail possums and rats readily take carrot baits containing d-pulegone (Day et al, 2000).

U.S. Pat. No. 5,877,223 relates to the use of d-pulegone as a dog repellent. There is no mention in the '223 patent of using d-pulegone as a bird repellent.

Anthraquinone is a commercially available compound (CAS No. 84-65-1). This compound has been recognized as an effective avian feeding deterrent since the 1950's (Neff and Meanley, 1957; GB1098687 and U.S. Pat. No. 3,941,887). The repellent properties of anthraquinone have been rigorously evaluated with several bird species over recent years (e.g. Avery et al. 1998, 2001). Anthraquinone operates via conditioned taste aversion. Birds must taste anthraquinone-treated food, experience the post-ingestional effects, and thereby learn to avoid the treated food (Avery et al 1997). Baits treated with anthraquinone are readily eaten by possums, and wild rodents readily take anthraquinone treated baits from bait stations (Day et al. 2000).

An alternative problem common in orchards and vineyards is the susceptibility of crops to bird attack. Traditional methods of repelling birds from ripening fruit include bird scarers that make noise; physical barriers between the ripening fruit and the bird; and sprays of individual repellent materials.

It will be appreciated that the above methods have a tendency to be labor intensive and often involve expensive capital costs. In addition, these methods alone are often not sufficient to deter birds from attacking ripening fruit.

It is an object of the invention to provide a bird repellent composition.

It is a further object of the invention to provide a repellent that can be used in pest control applications to repel birds.

It is a further object of the invention to provide a repellent that can be used in horticultural applications to repel birds.

It is a further object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicant reserves the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Further aspects and advantages of the present invention will become apparent from the ensuing description which is given by way of example only.

### BRIEF DESCRIPTION OF THE DRAWINGS

Further aspects of the present invention will become apparent from the following description which is given by way of example only and with reference to the accompanying drawings in which:

FIG. 1: Shows a possum-specific bait station used in accordance with the present invention as described in Example 1 and 2;

FIG. 2: Shows a rat-specific bait station used in accordance with the present invention as described in Example 1 and 2;

FIG. 3: Shows the peck frequency of standard versus repellent containing bait as described in Example 4;

FIG. 4: Shows the peck frequency of standard versus repellent containing bait as described in Example 5;

FIG. 5: Shows the peck frequency of standard versus repellent containing bait as described in Example 6;

FIG. 6: Shows the relatively repellence of different compositions on birds as described in Example 7;

FIG. 7: Shows the relatively repellence of different compositions on birds as described in Example 7;

FIG. 8: Shows the relatively repellence of different compositions on birds as described in Example 7;

FIG. 9: Shows the relatively repellence of different compositions on birds as described in Example 8;

FIG. 10: Shows the spectral reflectance profiles of the samples as described in Example 8, Experiment 1;

FIG. 11: Shows the relatively repellence of different compositions on birds as described in Example 8;

FIG. 12: Shows the spectral reflectance profiles of the samples as described in Example 8, Experiment 2;

FIG. 13: Shows the relatively repellence of different compositions on birds as described in Example 9;

FIG. 14: Shows the relatively repellence of different compositions on birds as described in Example 9; and

FIG. 15: Shows the relatively repellence of different compositions on birds as described in Example 10.

### DETAILED DESCRIPTION OF THE INVENTION

According to one aspect of the present invention there is provided a bird repellent composition containing one of the following combinations: anthraquinone and a visual cue; anthraquinone and d-pulegone; anthraquinone, a visual cue and d-pulegone; characterized in that the combination produces a synergistic effect of repellence to birds.

The applicant has found that combinations of anthraquinone and either a visual cue, d-pulegone or all three compounds gives an unexpected improvement in repellence of birds. Traditional methods do not utilize these combinations and in fact teach away from these combinations.

Preferably, the visual cue used is novel to the bird to be repelled. In one embodiment, the visual cue is a blue or green dye with a lowered relative reflective wavelength in the range from 500 to 700 nm. It will be appreciated by those skilled in the art that other visual cues are also possible.

Preferably the bird repellent composition is in a form selected from the group consisting of: a liquid spray; a liquid dip; a gel; a paste; a solid powder. It will be appreciated that other forms of application are also possible e.g. an aerosol.

In preferred embodiments, the bird repellent composition as described above is applied to an environment or object by means selected from the group consisting of: dipping; spraying; dusting; and combinations thereof. It will be appreciated that a variety of other application methods are possible however the above means are simple, cost effective and easy to use.

In preferred embodiments, the bird repellent composition as described above is applied to any one of the group consisting of: the ground; a discrete area of ground; a plant; a portion of a plant; fruit; vegetable matter; a nut or nuts; bait and combinations thereof.

For specific horticulture applications, the composition as described above is applied to any one of the group consisting of: ground in an orchard; ground in a vineyard; a grapevine; a fruit tree; fruit; vegetable matter; grapes; plant support structures; and combinations thereof.

As bird damage to horticultural crops is a significant problem, it is anticipated by the applicant that the bird repellent of the present invention will prove particularly advantageous for such uses.

Uses envisaged include application to the plant, fruit or ground of an orchard such as an apricot orchard. An alternative use is for vineyard applications where the composition is applied to the grapes, vines, support structures or ground of a vineyard to repel birds from ripening grapes.

It has been found by the applicant that the bird repellent composition remains effective as a bird repellent for a duration of at least 8 days. The length of time that the repellent remains effective will however depend on the environment into which it is to be applied. By way of example, for wet and/or humid environments, the repellent will need to be reapplied more frequently than dry environments.

It is also the applicants understanding that the repellent of the present invention has a combination of both primary and secondary repellence. It has been found by the applicant that the combination of a visual cue and/or olfactory stimulant primary repellents (novel color (e.g. blue or green dye) and d-pulegone), and a secondary repellent compound (anthraquinone), give a synergistic effect beyond that expected e.g. more effective than, for example, the repellence observed from using either repellent alone.

It will be appreciated by those skilled in the art that the composition of the present invention can be further combined with one or more excipients and/or carrier substances. Further substances may include water, oils such as peanut oil and pennyroyal oil and other known substances to give further properties such as water resistance characteristics and longer-term stability.

Preferably the bird repellent composition substantially as described above has an anthraquinone concentration from 0.001% to 5% by weight. It has been found by the applicant that such concentrations of anthraquinone produce the desired repellence effect. Adding more anthraquinone is also possible depending on the environment and/or application for which the repellent composition is used. For example, wet environments may require more anthraquinone and ground spray applications can be stronger as other pest repellence may not be of concern whereas in bait applications, the bait must still be attractive to the pest and hence is a consideration. It will be appreciated that lower concentrations are useful to reduce the cost of the repellent composition and need only be included until the desired effect is achieved.

Preferably, where if d-pulegone is used, the d-pulegone concentration is from 0.001% to 2% by weight. Like anthraquinone, it has been found by the applicant that such concentrations of d-pulegone produce the desired repellence effect. Adding more d-pulegone is also possible for specific environments and/or applications. It will also be appreciated that lower concentrations are useful to reduce the cost of the repellent composition and need only be included until the desired effect is achieved.

According to a further aspect of the present invention, there is provided a bait including a bird repellent composition substantially as described above.

In preferred embodiments, the bird repellent composition is applied to the bait surface.

The composition of the present invention has been found to be particularly successful in bait applications. Birds tend to eat poisonous baits used in animal eradication projects for example against possums and rats in New Zealand forests. By repelling birds from the bait, the process of using such baits may become more acceptable to at least the public as fewer non-target species (birds) will be harmed.

Preferred bait base material is selected from group consisting of: a cereal; a carrot; a dough. It will be appreciated by those skilled in the art that the bait base material is however primarily dependent on the pest to be attracted, so other bait materials may be used with the repellents. Certain pests prefer certain base materials. It is the applicants finding however that the repellent composition of the present invention does not cause any effects (positive or negative) on the attractiveness/palatability of the bait to the pest.

In preferred embodiments, the pests on which the bait of the present invention is used are animals including possums and rats. Such pests cause significant damage to native flora and fauna at least in New Zealand and hence a number of bait programs exist to catch and/or kill possum and/or rat populations. Where such populations co-habit the same geographical area, the bait and bird repellent combination is particularly advantageous to use as it avoids non-target species (birds) being poisoned by the bait or hurt in animal traps.

According to yet a further aspect of the present invention, there is provided a method of repelling birds from an environment or object including the steps of selecting the environment to which the repellent is to be applied, and applying the repellent substantially as described above to the environment or object.

According to yet a further aspect of the present invention, there is provided a method of repelling birds from bait including the step of applying a bird repellent composition substantially as described above to the bait.

According to yet a further aspect of the present invention, there is provided the use of a bird repellent composition substantially as described above to repel birds from an environment or object, wherein the repellent is applied to the environment or object from which the birds are to be repelled.

According to yet a further aspect of the present invention, there is provided the use of a bird repellent composition substantially as described above with a bait by applying the bird repellent composition to the bait.

It can be seen from the above description that there is provided a bird repellent composition, which is synergistic in nature to more effectively repel birds. The repellent can be applied as a spray or dip or other application method to an environment or object such as a plant or the ground around a plant, or on pest baits. By application to plants or the ground, the repellent composition is useful in horticultural applications whereby birds can be successfully repelled from, for example ripening fruit. In bait applications the birds are repelled from potentially toxic baits and/or traps that in themselves can harm the bird.

### BEST MODE FOR CARRYING OUT THE INVENTION

The invention is now further described with reference to experimental results obtained for various configurations of the present invention.

Three key studies are included below to show the effects of the invention embodiments on:
[I] The palatability of the repellent compounds of the present invention to possums and rats;
[II] The repellence effect from bait treated with repellent compounds of the present invention on North Island robin and any effects attributable to the means with which the compounds are applied to the bait;
[III] The repellence effect from wheat treated with repellent compounds of the present invention on sparrows.

### [I] The Palatability of the Repellent Compounds of the Present Invention to Possums and Rats

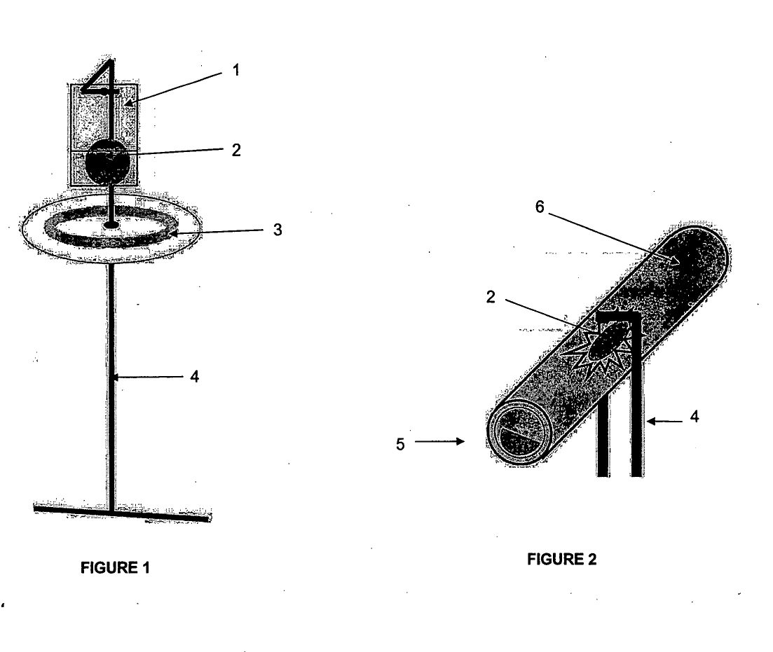

To determine the palatability of baits to wild possums and wild rats, possum-specific bait stations and rat-specific bait stations were established in bush-pasture margin and forest habitats (see FIG. 1 and FIG. 2).

The possum-specific bait station (FIG. 1) is mounted on an elevated wire stake 4 with bait 2 attached in a perforated bag 1 at top of wire 4. A plastic disc 3 is used to stop rodents (not shown) climbing wire 4 has plasticine (not shown) on it to record animal activity.

The rat-specific bait station (FIG. 2) is an approximately 60 mm diameter tube 6 with bait 2 placed in the centre and tube 6 is pinned to ground with holding stake 4. Plasticine 5 is added at either end of the tube 6 to record animal activity.

The bait stations (FIGS. 1 and 2) enable determination of the response of possums or rats to bait 2. Plasticine 5 is used to record the presence (e.g. footprints, claw marks, bite marks) and species of animal present at the bait station.

### EXAMPLE 1

### The Palatability of Varying Baits and Varying Bird Repellent Compounds on Possums and Rats

In this example the repellence of neem (a known repellent), lime (a known repellent), anthraquinone and d-pulegone (compounds of the present invention) in cereal, carrot and paste baits are tested on wild possums and rats.

The following bait treatments are compared:
standard (solution of dye+water+0.1% cinnamon oil)
cinnamamide (solution of dye+water+0.5% cinnamamide)
neem (solution of dye+water+2% neem oil)
lime (solution of dye+water+2% agricultural lime)
anthraquinone (solution of dye+water+0.75% anthraquinone formulation).
d-pulegone (solution of dye+water+1% d-pulegone)
salt (solution of dye+water+salt (10% of total bait weight))

All quantities are given in percent by weight.

Treatments are applied to the cereal and carrot bait surface at a rate of 10% of total bait weight. The treatments are applied to the paste bait by mixing the solution through the bait, again at a rate of 10% of total bait weight.

Cinnamamide is used as a positive control, as cinnamamide is a known bird repellent. Salt baits are used as a negative control, as food containing high salt concentrations is known to be unpalatable to possums.

The treatments are placed on the bait stations as described above and possum and rat activity measured.

1.1 Possums

Fewer cereal bait stations were touched at first exposure than carrot or paste bait stations, but there was no difference in the proportion of bait stations left untouched in subsequent exposures (Table 1). There was also no difference between the three bait types when encountered at first or subsequent exposures (Table 1).

TABLE 1
Proportion of bait stations from each bait type left
untouched or with bait eaten when encountered at first
and subsequent exposures by wild possums.

| | Untouched | | Eaten | |
|---|---|---|---|---|
| Treatment | First Exposure | Subsequent | First Exposure | Subsequent |
| Cereal | 0.68 | 0.33 | 0.66 | 0.95 |
| Carrot | 0.33 | 0.28 | 0.75 | 0.94 |
| Paste | 0.40 | 0.31 | 0.79 | 0.94 |

The proportion of bait stations left untouched did not differ between bait treatments at first or subsequent exposures (Table 2). The proportion of baits eaten when encountered was significantly lower for salt baits than for standard bait, but the proportion of other bait treatments eaten did not differ from standard bait at first or subsequent exposures (Table 2).

TABLE 2
Proportion of bait stations from each bait treatment
left untouched or with bait eaten when encountered at
first and subsequent exposures by wild possums.

| | Untouched | | Eaten | |
|---|---|---|---|---|
| | First | | First | |
| Treatment | Exposure | Subsequent | Exposure | Subsequent |
| Standard | 0.58 | 0.33 | 0.80 | 0.98 |
| Cinnamamide | 0.55 | 0.29 | 0.71 | 0.95 |
| Neem | 0.48 | 0.32 | 0.81 | 0.94 |
| Lime | 0.45 | 0.22 | 0.71 | 0.95 |
| Anthraquinone | 0.67 | 0.35 | 0.80 | 1.00 |
| d-pulegone | 0.52 | 0.30 | 0.87 | 0.98 |
| Salt | 0.37 | 0.29 | 0.30 | 0.38 |

There was no difference in possum feeding behavior (e.g. time spent feeding on bait 2, number of attempts to open bait bag 1) between the repellent treated and the control or positive control baits 2.

1.2 Rats

The results found for rats are shown in Table 3 below.

TABLE 3
Proportion of bait stations from each bait type
left untouched, or eaten when encountered at first
and subsequent exposures by wild rats.

| | Untouched | | Eaten | |
|---|---|---|---|---|
| Treatment | First Exposure | Subsequent | First Exposure | Subsequent |
| Cereal | 0.62 | 0.35 | 0.96 | 0.99 |
| Carrot | 0.89 | 0.60 | 0.00 | 0.60 |
| Paste | 0.71 | 0.65 | 0.25 | 0.53 |

When rats encountered bait stations they readily ate cereal baits at first exposure, but ate significantly fewer carrot or paste baits (Table 3). There were no significant differences between the bait treatments eaten at first exposure, (Table 3) except for salt (negative control) which were not eaten. In subsequent exposures, cereal baits were eaten more readily than carrot or paste baits (Table 4).

TABLE 4
Proportion of bait stations from each bait treatment
left untouched, or eaten when encountered at first
and subsequent exposures by wild rats.

| | Untouched | | Eaten | |
|---|---|---|---|---|
| | First | | First | |
| Treatment | Exposure | Subsequent | Exposure | Subsequent |
| Standard | 0.65 | 0.50 | 0.44 | 0.73 |
| Cinnamamide | 0.77 | 0.66 | 0.67 | 0.70 |
| Neem | 0.78 | 0.56 | 0.67 | 0.63 |
| Lime | 0.78 | 0.61 | 0.80 | 0.61 |
| Anthraquinone | 0.64 | 0.57 | 1.00 | 0.65 |
| d-pulegone | 0.63 | 0.55 | 0.70 | 0.75 |
| Salt | 0.86 | 0.72 | 0.00 | 0.16 |

### EXAMPLE 2

### The Palatability of Different Combinations of Bird Repellent Compounds to Wild Possums and Rats

The following bait treatments were compared (only carrot baits are compared):
standard (solution of dye+water+0.1% cinnamon oil)
anthraquinone 1 (solution of dye+water+1% anthraquinone formulation)
anthraquinone 2 (solution of dye+water+2% anthraquinone formulation)
d-pulegone 1 (solution of dye+water+1% d-pulegone)
d-pulegone 2 (solution of dye+water+2% d-pulegone)
combination 1 (solution of dye+water+1% anthraquinone formulation+1% d-pulegone)
combination 2 (solution of dye+water+2% anthraquinone formulation+2% d-pulegone)
salt (solution of dye+water+salt (10% of total bait weight))

All quantities given in percent by weight and all bait treatment, bait station set-up and subsequent measurement are as described in Example 1.

2.1 Possums

There was no significant difference between the bait treatments in the proportion of baits left untouched at first exposure (Table 5). The proportion of baits eaten did not differ between treatments at first exposure, but in subsequent exposures salt baits (negative control) were eaten less (Table 5). All baits were generally either mostly eaten or completely eaten after several exposures.

TABLE 5
Proportion of bait stations from each bait treatment
left untouched or eaten when encountered at first
and subsequent exposures by wild possums.

| | Untouched | | Eaten | |
|---|---|---|---|---|
| | First | | First | |
| Treatment | Exposure | Subsequent | Exposure | Subsequent |
| Standard | 0.73 | 0.64 | 0.67 | 0.83 |
| Anthraquinone 1 | 0.36 | 0.52 | 0.57 | 0.94 |
| Anthraquinone 2 | 0.55 | 0.45 | 1.00 | 0.83 |
| d-pulegone 1 | 0.82 | 0.58 | 1.00 | 1.00 |
| d-pulegone 2 | 0.64 | 0.55 | 1.00 | 1.00 |
| Combination 1 | 0.45 | 0.39 | 1.00 | 1.00 |
| Combination 2 | 0.73 | 0.64 | 1.00 | 0.92 |
| Salt | 0.82 | 0.30* | 1.00 | 0.43* |

2.2 Rats

The results found for rats are shown in Table 6 below.

TABLE 6
Proportion of bait stations from each bait treatment
left untouched, or eaten when encountered at first
and subsequent exposures by wild rats.

| | Untouched | | Eaten | |
|---|---|---|---|---|
| | First | | First | |
| Treatment | Exposure | Subsequent | Exposure | Subsequent |
| Standard | 0.50 | 0.53 | 0.25 | 0.80 |
| Anthraquinone 1 | 0.82 | 0.46 | 0.50 | 0.85 |
| Anthraquinone 2 | 0.82 | 0.48 | 0.50 | 0.81 |
| d-pulegone 1 | 0.50 | 0.66 | 0.80 | 0.82 |
| d-pulegone 2 | 0.60 | 0.37 | 0.50 | 0.82 |
| Combination 1 | 0.56 | 0.41 | 0.50 | 0.76 |
| Combination 2 | 0.64 | 0.60 | 0.50 | 0.83 |
| Salt | 0.18 | 0.50 | 0.22 | 0.33* |

On first exposure all treatments were eaten more readily than the standard. The combination of anthraquinone and d-pulegone had a similar palatability to other treatments, (Table 6).

### EXAMPLE 6

### The Kill Effect of Rat Baits Treated With Bird Repellent Compounds

The repellent efficacy for rat poisons was further checked.

In the experiment, rats are offered toxic carrot baits containing 0.15% sodium monoflouroacetate (the toxin) and combinations of repellents (or a control bait).

The repellents used on the toxin containing baits were as follows:
Control baits—green dye and cinnamon oil (non repellent standard baits used for pest control in NZ);
Blue dye and anthraquinone 1%;
Blue dye and anthraquinone 1% with 1% peanut oil.
Blue dye and anthraquinone 1%+0.1% peanut oil

All quantities are given in weight percent.

The results found were as shown in Table 7 below:

TABLE 7
Rat trial results

| | Fate of rat | | |
|---|---|---|---|
| Bait type | Dead | Unwell | Recovered |
| Blue dye and anthraquinone 1% | 6 | 2 | 1 |
| Blue dye, anthraquinone 1% and | 5 | 3 | 1 |
| 1% peanut | | | |
| Blue dye, anthraquinone 1% and | 9 | 0 | 0 |
| 0.1% peanut | | | |
| Control | 9 | 0 | 0 |

The results found were that the use of blue dye, anthraquinone and/or different peanut oil combinations gave no significant difference in the number of rats killed compared to other treatments.

Therefore, the repellent compounds of the invention do not impact on the kill effects of repellent treated bait to the pest.

### [II] The Repellence Effect From Bait Treated With Repellent Compounds on North Island Robins

The repellent compounds effect on robins is compared. Evidence from poisoning operations suggests that North Island robins, Petroica australis longipes eat cereal or carrot baits (or bait fragments known as ‘chaff’).

### EXAMPLE 4

### The Repellence Effect on North Island Robins From Bait Treated With Blue Dye, Anthraquinone and Combinations of These Compounds Compared to Standard Repellent Compounds

This experiment investigates whether the addition of a novel visual cue and a secondary repellent (anthraquinone) to baits influences the feeding behavior of wild robins.

Robins were trained to approach observers within their territory and were offered repellent-treated (blue color+anthraquinone) and standard (green color+cinnamon oil, as used for pest control operations in New Zealand) dough baits over four consecutive days on a test arena on a forest floor.

Blue dye is used as the novel visual cue as this is known to have the least repellent effect from prior art experiments. By proving an effect with blue dye, it can be assumed that similar deterrent effects can also be attained using visual cues that are known to have a greater repellent effect on birds.

Both choice and no-choice tests were used to record the feeding behavior of robins towards the baits.

The results are shown below in Tables 8 and 9:

TABLE 8
Adjusted mean number of pecks (±SE) by robins directed at standard
or repellent bait, summarized by season and robin class.

Peck frequency (mean ± SE)

| Factor | Standard | Repellent |
|---|---|---|
| Bait type × season | | |
| Winter | 5.5 ± 1.5 | 1.0 ± 0.4 |
| Summer | 2.5 ± 0.9 | 0.5 ± 0.2 |
| Bait type × robin class | | |
| Male | 3.3 ± 1.0 | 0.4 ± 0.2 |
| Female | 3.7 ± 1.7 | 0.7 ± 0.4 |
| Juvenile | 4.7 ± 3.0 | 1.6 ± 1.3 |
| Bait type × test type | | |
| Choice test | 3.8 ± 0.9 | 0.4 ± 0.2 |
| No-choice test | 4.0 ± 2.2 | 1.3 ± 0.9 |

TABLE 9
Total number of standard and repellent baits removed
from the test arena by robins during winter and summer
choice tests and the winter no-choice test.

| Season and trial type | N (birds) | Standard | Repellent |
|---|---|---|---|
| Summer choice test | 22 | 10 | 2 |
| Winter choice test | 20 | 26 | 2 |
| Winter no-choice test | 14 | 18 | 9 |
| Total | 56 | 54 | 13 |

The end result of the baits removed (eaten, dropped unknown) is described in Table 10 below.

TABLE 10
Total number of standard and repellent baits that were
eaten, dropped or taken out of sight (unknown result) by
robins when they removed baits from the test arena.

| | Standard | Repellent |
|---|---|---|
| Eaten | 10 | 1 |
| Dropped | 3 | 5 |
| Unknown | 41 | 7 |
| Total | 54 | 13 |

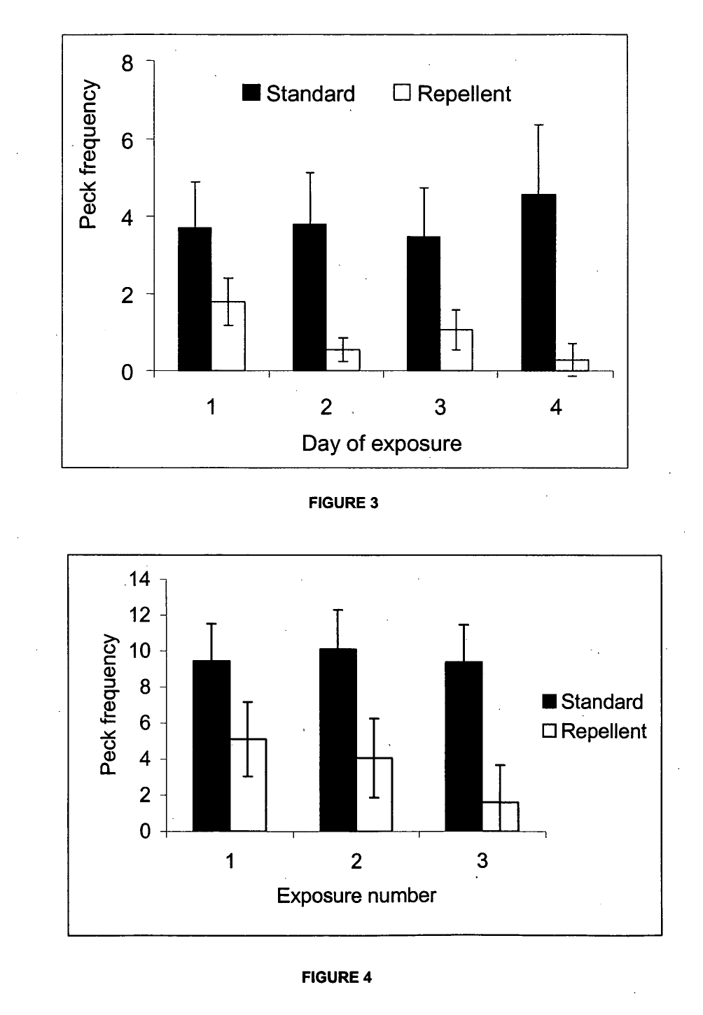

Further results are also shown in FIG. 3, which shows the adjusted mean number of pecks (±SE) by robins directed at standard or repellent baits over 4 days of exposure.

Robins were found to peck at standard baits more frequently than repellent baits, with the frequency of pecking at repellent baits declining over the four days.

Choice and no-choice tests produced similar levels of pecking response towards both bait types.

The results demonstrate that, relative to standard baits, the combination of blue dye and anthraquinone effectively deters most robins from feeding, with evidence of learned avoidance.

### EXAMPLE 5

### The Repellence Effect on North Island Robins From Bait Treated With D-Pulegone and Anthraquinone Compounds Compared to Standard Repellent Compounds

In this example the repellence of robins to dough baits treated with a repellent consisting of anthraquinone and d-pulegone is compared.

A test arena, consisting of a 0.5 m×0.5 m area scraped clear of leaf litter was used. Robins were offered a choice between two types of green-dyed dough bait in the test arena.

Two bait treatments sprayed onto the dough bait surface were used:
Standard (green dough bait coated with a solution of water+0.1% cinnamon oil)
Repellent (green dough bait coated with a solution of water+2% anthraquinone formulation+2% d-pulegone).

All quantities given in percent by weight.

At first exposure, all robins came to the test arena and pecked at one or both of the bait types. Robins pecked at standard baits more frequently than they pecked at repellent baits (FIG. 4). The frequency of pecking repellent treated baits reduced over subsequent exposures indicating both primary and secondary repellence effects.

The feeding behavior of robins towards baits differed. Robins removed standard baits from the arena more frequently than they removed repellent baits (Table 11) and they tended to eat standard baits when they removed them. In contrast, they did not eat repellent treated baits when they removed them from the arena (Table 11).

TABLE 11
Number of baits removed from the test arena by robins
during all exposures to baits and fate of the baits
when removed (eaten, dropped or unknown).

| Fate of bait | Standard | Repellent |
|---|---|---|
| Eaten | 16 | 0 |
| Dropped | 0 | 8 |
| Unknown | 16 | 12 |
| Total | 32 | 20 |

In summary it was found that bait treated with d-pulegone and anthraquinone was significantly less preferred than standard repellent treatment. In addition, where bait was removed from the test arena, bait treated with d-pulegone and anthraquinone was less likely to be subsequently eaten compared to standard treatments which were often eaten.

### EXAMPLE 6

### The Influence of Application Method is Determined

The same method was used as in Example 5, except the treatments were applied to the bait by dipping into treatment solutions rather than spraying in Example 5.

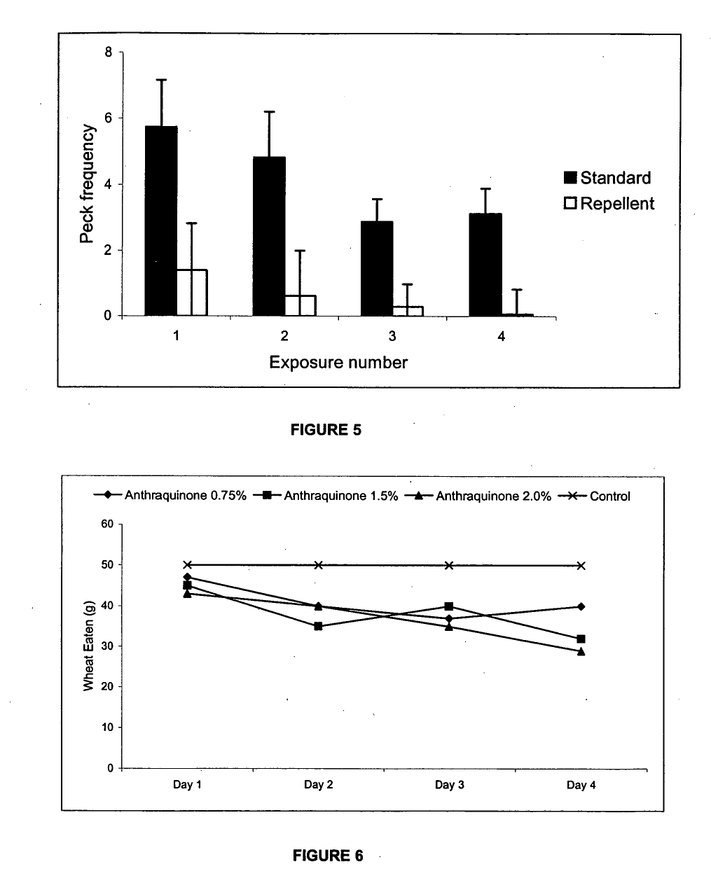

At first exposure, all robins came onto the test arena. Robins that pecked at baits pecked at standard baits more frequently than they pecked at repellent baits during first and subsequent exposures (FIG. 5). Pecking at repellent treated baits reduced over the subsequent exposures.

Robins removed standard baits from the arena more frequently than they removed repellent baits (Table 12). They also tended to eat standard baits when they removed them. Robins did not eat repellent treated baits when removed from the arena (Table 12).

TABLE 12
Number of baits removed from the test arena by robins
during all exposures to baits and fate of the baits
when removed (eaten, dropped or unknown).

| Fate of bait | Standard | Repellent |
|---|---|---|
| Eaten | 7 | 0 |
| Dropped | 2 | 6 |
| Unknown | 19 | 7 |
| Total | 28 | 13 |

As in Example 5, bait treated with d-pulegone and anthraquinone was significantly less preferred than standard repellent treatment and were also less likely to be subsequently eaten compared to standard treatments. In addition no influences are noted between different methods of application i.e. spraying on the repellent compounds versus dipping.

### [III] The Repellence Effect on Sparrows of Various Repellent Compounds Applied to Wheat

### EXAMPLE 7

### Repellence Effect on Sparrows From Differing Levels of Anthraquinone. d-Pulegone Blue Dye and Combinations of These Compounds Applied to Wheat

Wild sparrow tests were used to determine the effect of the individual repellency compared with the combination repellency.

On sparrow feed tables, sparrows were offered a choice between control wheat and three doses of repellent treated wheat.

Dose response studies showed that an anthraquinone formulation reduced the amount of wheat eaten by sparrows on days 3 and 4 of presentation relative to control wheat (FIG. 6).

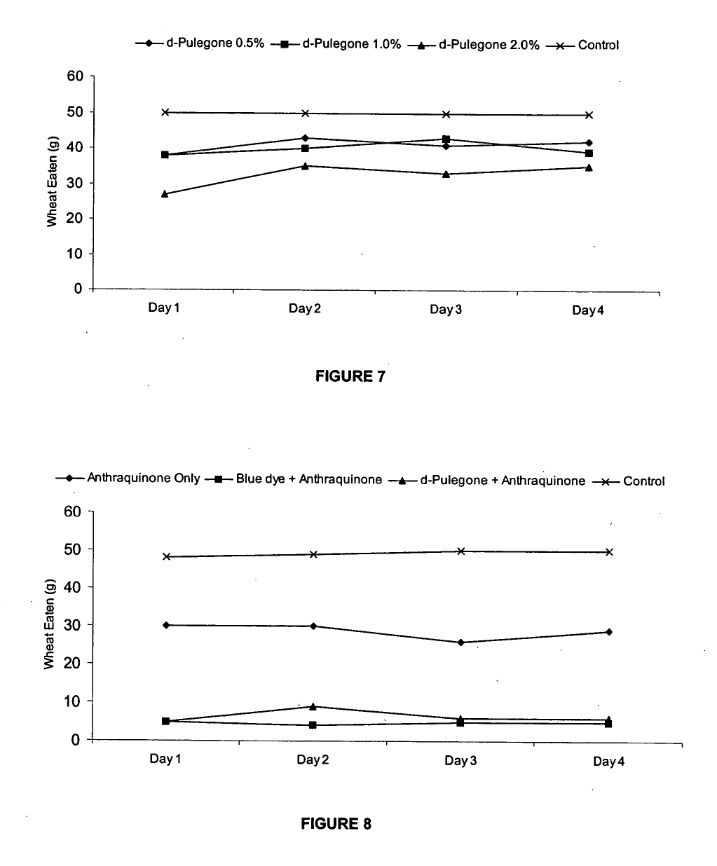

Similarly, dose response studies showed that d-Pulegone also reduced the quantity of wheat eaten by sparrows on days 1, 3 and 4 (FIG. 7).

When the anthraquinone formulation and d-pulegone were combined the wheat consumption of sparrows was significantly lower than when anthraquinone and d-pulegone are used alone as repellents (FIG. 8). Similarly, for a combination of blue dye and anthraquinone the combined effect is were significantly more than anthraquinone alone.

In summary, an unexpected and synergistic effect is noted on bird repellency for combinations of either blue dye and anthraquinone or d-pulegone and anthraquinone.

### EXAMPLE 8

### Repellence Effect on Sparrows From Differing Levels of Anthraquinone Compound in Combination With Other Compounds When Applied to Wheat

The feeding behavior of free-ranging house sparrows (Passer domesticus) presented wheat treated with anthraquinone paired with either a novel visual cue (blue dye), cinnamon oil (containing primarily olfactory cues), or d-pulegone (containing olfactory and taste cues), was recorded, to determine the suitability of repellent combinations for preventing non-target birds from consuming pesticides or other harmful substances.

Eight independent populations of house sparrows, were trained to eat plain hulled wheat from four identical food trays on feed tables.

8.1 Experiment 1

In Experiment 1, sparrows were presented, for 4-day periods, with a choice between plain wheat, anthraquinone treated wheat, and two of the remaining repellent combinations (anthraquinone and cinnamon oil, anthraquinone and blue dye, anthraquinone and d-pulegone (at 0.5% wt or 2.0% wt concentrations)) until all sparrow populations had been exposed to each repellent.

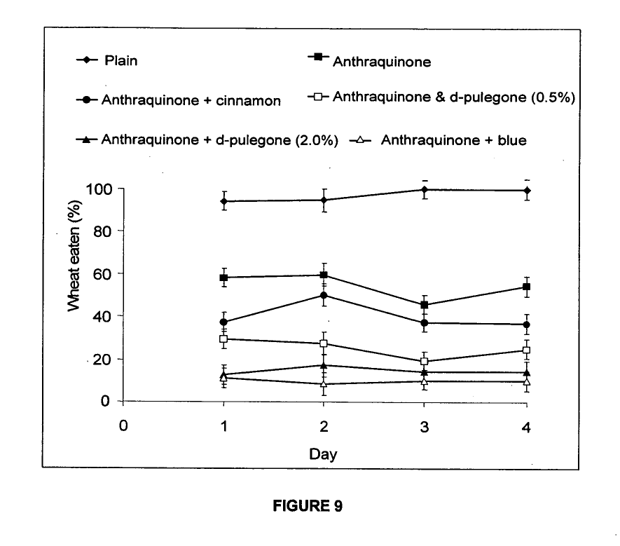

The results are shown in FIG. 9 which shows the mean (±SED) daily percentage of wheat eaten over the 4-day test periods in Experiment 1 by house sparrows offered a choice between plain wheat, anthraquinone treated wheat and two of the other wheat treatments: anthraquinone and cinnamon oil (novel odor), anthraquinone and blue dye (novel color), anthraquinone and 0.5% wt d-pulegone, or anthraquinone and 2% wt d-pulegone.

The consumption of plain wheat and anthraquinone treated wheat was compared to the consumption of the repellent combinations every 24 hr.

Plain wheat was almost always fully consumed at each table each day; over the same timeframe, anthraquinone significantly reduced wheat consumption, to 54% of that offered. Addition of cinnamon oil to wheat with anthraquinone did not further reduce consumption (41%), but when anthraquinone was paired with either blue dye or d-pulegone, repellency was enhanced.

The combinations of anthraquinone and 2% wt d-pulegone or anthraquinone and blue dye elicited the most effective avoidance responses (14.6% and 9.6% consumption, respectively).

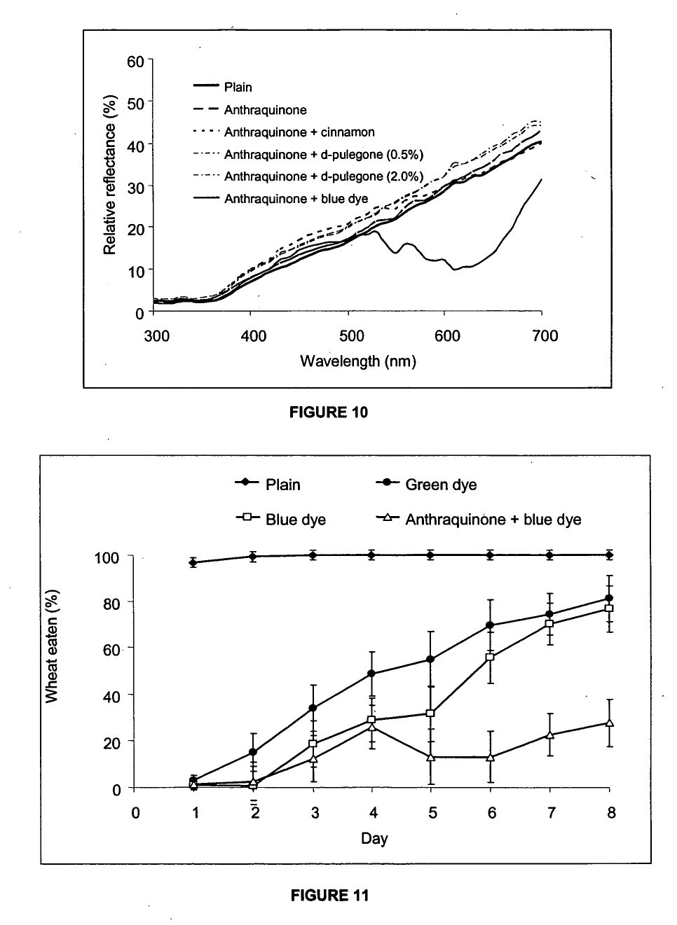

A further analysis was completed to determine the spectral reflectance profiles (wavelength) for each of the samples of Experiment 1. The results are shown in FIG. 10. In particular, the blue dyed samples had a lowered relative reflectance wavelength in the range from 500 to 700 nm.

8.2 Experiment 2

In Experiment 2, the same populations and food tables were used to compare the consumption of plain wheat to that of wheat treated with either anthraquinone and blue dye, blue dye alone, or green dye alone on each table. An 8-day time period was used to determine repellency levels over a longer timeframe than had been examined in Experiment 1.

The results are shown FIG. 10 which shows the mean (±SED) daily percentage of wheat eaten over the 8-day test period in Experiment 2 by house sparrows offered a choice between plain wheat and three types of treated wheat: green dye, blue dye or anthraquinone and blue dye in combination.

While sparrows ate all plain wheat that was offered every day, they initially avoided all three treated wheat types. Over time, sparrows progressively consumed more green and blue dyed wheat each day, eating significantly more of these treatments than anthraquinone and blue dye by day 5.

Overall, green dyed wheat was consumed more readily (47.5%) than blue dyed wheat (35.3%) or anthraquinone and blue dyed wheat (14.7%).

Color alone did not provide a long-lasting avoidance response in sparrows.

The data found clearly demonstrates the potential of combining anthraquinone with additional visual, olfactory or taste cues for modifying the feeding behavior of birds.

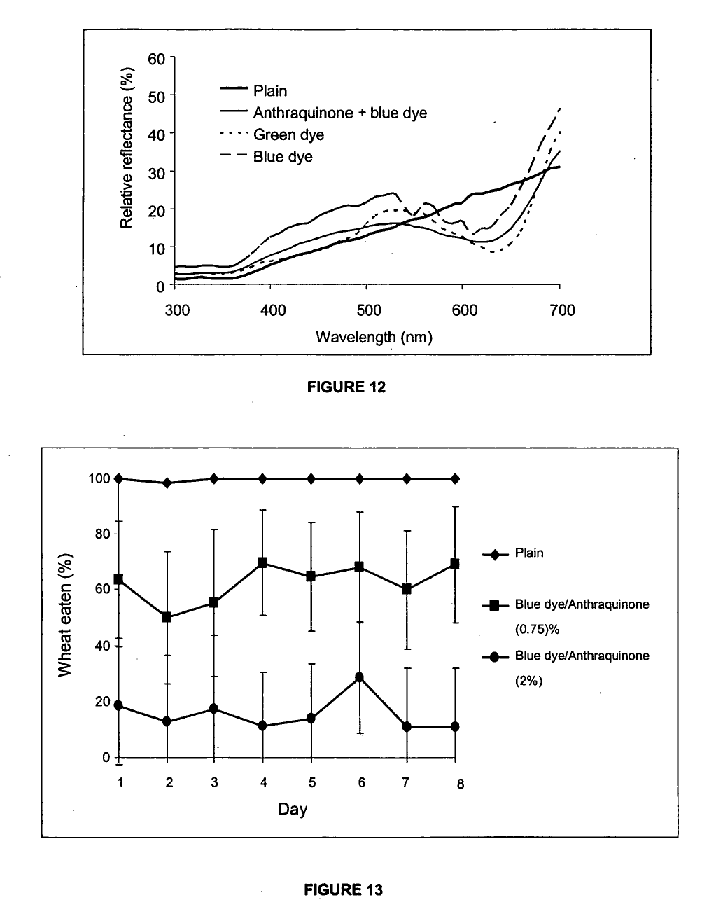

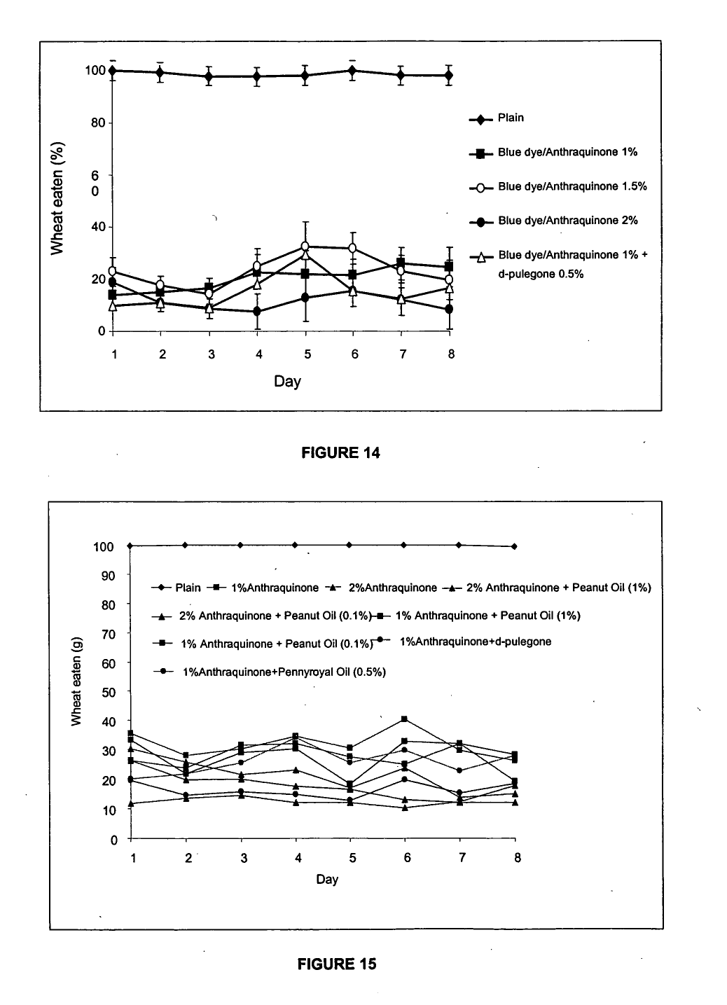

Like Experiment 1, a further analysis was completed to determine the spectral reflectance profiles (wavelength) for each of the samples of Experiment 2. The results are shown in FIG. 12. Both the blue and green dyed samples of Experiment 2 had a lowered relative reflectance wavelength in the range from 500 to 700 nm.

### EXAMPLE 9

### Repellence Effect on Sparrows From Differing Concentrations of Anthraquinone Compound in Combination With Blue Dye and/or D-Pulegone When Applied to Wheat

Effective repellent concentration ranges and combinations—the effect of blue dye and anthraquinone is investigated as well as in combination with d-pulegone.

Similar methodology is used to that discussed in Example 8 above.

The results found are shown in FIGS. 11 and 12.

In the first experiment blue dye and anthraquinone is found to be less effective at 0.75% wt concentration than at an anthraquinone concentration of 2% wt for house sparrows, although both concentrations have a repellent effect.

In the second experiment, it can be seen that blue dye and anthraquinone are effective at a 1% wt concentration or more of anthraquinone.

Also, the combination of blue dye and a 1% wt concentration of anthraquinone as well as a 0.5% wt concentration of d-pulegone is also an effective repellent for sparrows

### EXAMPLE 10

### Repellence Effect on Sparrows From Differing Concentrations of Anthraquinone Compound in Combination With Blue Dye are Further Mixed With Known Excipients to Determine if Any Unexpected Effects Found

The same methodology as Example 8 is used except further excipients are used including peanut oil (at 1% wt and 0.1% wt concentration) and pennyroyal oil (0.5% wt concentration).

The results are shown in FIG. 13.

No significant differences in repellence were noted between compositions containing excipients and those not containing excipients.

### SUMMARY OF THE EXAMPLES

The examples above show that the combination of anthraquinone and either blue dye or d-pulegone or all three compounds have a significantly increased effect on repellency of birds.

Further, Examples 1 and 2 show that there is no loss in palatability to pests such as possums and rats, an important factor when using the repellent in a toxic pest control bait.

Aspects of the present invention have been described byway of example only and it should be appreciated that modifications and additions may be made thereto without departing from the scope thereof as defined in the appended claims.

### REFERENCES

Avery, M. L., Humphrey, J. S., Decker, D. G., 1997. Feeding deterrence of anthraquinone, anthracene, and anthrone to rice-eating birds. Journal of Wildlife Management 61, 1359 1365.
Avery, M. L., Humphrey, J. S., Primus, T. M., Decker, D. G., McGrane, A. P., 1998. Anthraquinone protects rice seed from birds. Crop Protection 17, 225 230.
Avery, M. L., Mason, J. R., 1997. Feeding responses of red-winged blackbirds to multisensory repellents. Crop Protection 16, 159 164.
Avery, M. L., Nelms, C. O., 1990. Food avoidance by red-winged blackbirds conditioned with pyrazine odor. Auk 107, 544 549.
Avery, M. L., Tillman, E. A, Laukert, C. C., 2001. Evaluation of chemical repellents for reducing crop damage by Dickcissels in Venezuela. International Journal of Pest Management 47, 311 314.
Brown, K. P., 1997. Impact of brodifacoum poisoning operations on South Island robins Petroica australis australis in a New Zealand Nothofagus forest. Bird Conservation International 7, 399 407.
Caithness, T. A., Williams, G. R., 1971. Protecting birds from poison baits. New Zealand Journal of Agriculture 12, 38 43.
Clark, L., 1998. Physiological, ecological, and evolutionary bases for the avoidance of chemical irritants by birds. Current Ornithology 14, 1 37.
Day, T. D., Matthews, L. R., Flight, K. E., Aukett, M. A. 2000. Low Cost Repellents for Possum Baits. AgResearch Ltd Contract Report for the Animal Health Board, November.
Day, T. D., Matthews, L. R., 1999. Do colours that deter birds affect cereal bait acceptance by possums (Trichosurus vulpecula)? New Zealand Journal of Ecology 23, 261 266.
Domjan, M., 1998. The Principles of Learning and Behaviour, fourth ed. Brooks/Cole, Pacific Grove, Calif., USA.
Empson, R. A., Miskelly, C. M., 1999. The risks, costs and benefits of using brodifacoum to eradicate rats from Kapiti Island, New Zealand. New Zealand Journal of Ecology 23,241 254.
Fitzgerald, G., Williams, R., Saunders, L., 2000. Public perceptions and issues in possum control. In: Montague, T. L. (Ed.), The Brushtail Possum: Biology, Impact, and Management of an Introduced Marsupial. Manaaki Whenua Press, Christchurch, pp.187 197.
Great Britain Patent No. GB1098687
Hartley, L. J., O'Connor, C. E., Waas, J. R., Matthews, L. R., 1999. Colour preferences in North Island robins (Petroica australis): implications for deterring birds from poisonous baits. New Zealand Journal of Ecology 23, 255 260.
Hartley, L. J., Waas, J. R., O'Connor, C. E., Matthews, L. R., 2000. Colour preferences and coloured bait consumption by weak Gallirallus australis, an endemic New Zealand rail. Biological Conservation 93, 255 263.
Innes, J., Hay, R., Flux, I., Bradfield, P., Speed, H., Jansen, P., 1999. Successful recovery of North Island kokako (Callaeas cinera wilsoni) populations, by adaptive management. Biological Conservation 87, 201 214.
Mason, J. R., 1990. Evaluation of de-pulegone as an avian repellent. Journal of Wildlife Management 54, 130 135.
Mason, J. R., Reidinger, R. F., 1983. Importance of color for methiocarb-induced food aversions in red-winged blackbirds. Journal of Wildlife Management 47, 383 393.
Mastrota, F. N., Mench, J. A., 1995. Evaluation of taste repellents with northern bobwhites for deterring ingestion of granular pesticides. Environmental Toxicology and Chemistry 14, 631 638.
Morgan, D. R., 1999. Risks to non-target species from use of a gel bait for possum control. New Zealand Journal of Ecology 23, 281 288.
Neff, J. A., Meanley, B., 1957. Research on Bird Repellents. Bird Repellent Studies in the Eastern Arkansas Rice Fields. US Department of Interior Wildlife Research Laboratory, Denver, Colo. (Unpublished Report).
Nelms, C. O., Avery, M. L. , 1997. Reducing bird repellent application rates by the addition of sensory stimuli. International Journal of Pest Management 43, 187 190.
Powersland, R. G., Knegtmans, J. W., Marshall, I. S. J., 1999. Costs and benefits of aerial 1080 possum control operations using carrot baits to North Island robins (Petroica australis longipes), Pureora Forest Park. New Zealand Journal of Ecology 23, 149 159.
Rogers, J. G., 1978. Repellents to protect corps form vertebrate pests: some considerations for their use and development. In: Bullard, R. W. (Ed.), Flavour Chemistry of Animal Foods. American Chemical Society, Washing, pp. 150 165.
Sayre, R. W., Clark, L., 2001. Comparison of primary and secondary repellents for aversive conditioning of European starlings. In: Johnston, J. J. (Ed.), Pesticides and Wildlife, 2001. (Ed.), American Chemical Society Series771. Oxford University Press, Washington D.C., USA.
Spurr, E. B., 1991. Effects of brushtail possum control operations on non-target bird populations. Proceedings of the XX International Ornithological Congress, pp.2534 2545.
Spurr, E. B., 2000. Impacts of possum control on non-target species. In: Montague, T. L. (Ed.), The Brushtail Possum: Biology, Impact, and Management of an Introduced Marsupial. Manaaki Whenua Press, Christchurch, pp. 175 186.
Spurr, E. B., Porter, R. E. R., 1998. Cinnamamide as a bird repellent for baits used in mammalian pest control. In: Proceedings of the 11^{th} Australian Vertebrate Pest Conference, pp. 295 299.
Spurr, E. B., Porter, R. E. R., Thomson, C., 2001. Palatability of bird repellents to Rattus norvegicus. Pest Management Science 57, 615 619.
U.S. Pat. No. 3,941,887
U.S. Pat. No. 5,877,223
Wager-Page, S. A., Mason J. R., 1996. Exposure to volatile d-pulegone alters feeding behaviour in European starlings. Journal of Wildlife Management 60, 917 922.

1. A bird repellent composition comprising one of the following combinations: anthraquinone and a visual cue; anthraquinone and d-pulegone; or anthraquinone, a visual cue, and d-pulegone; wherein the visual cue is a blue or green dye with a lowered relative reflective wavelength in the range from 500 to 700 nm, and wherein the combination produces a synergistic effect of repellence to birds.

2. The bird repellent composition of claim 1 wherein the composition is in a form selected from the group consisting of a liquid spray, a liquid dip, a gel, a paste and a solid powder.

3. The bird repellent composition of claim 1 wherein the repellent composition is applied to an environment or an object by a means selected from the group consisting of dipping, spraying, dusting and combinations thereof.

4. The bird repellent composition of claim 1, wherein the composition is applied to one of the group consisting of a ground, a discrete area of ground, a plant, a portion of a plant, a fruit, a nut or nuts, a bait, and combinations thereof.

5. The bird repellent composition of claim 1, wherein the composition is applied to one of the group consisting of ground or a discrete area of ground in an orchard, ground or a discrete area of ground in a vineyard, a grapevine, a fruit tree, a fruit, vegetable matter, a grape, a plant support structure, and combinations thereof.

6. The bird repellent composition of claim 1, wherein the duration of repellent effect is for at least 8 days.

7. The bird repellent composition of claim 1, wherein the repellency effect is a combination of both primary and secondary repellence.

8. The bird repellent composition of claim 1, wherein the composition is further combined with one or more excipients and/or carrier substances.

9. The bird repellent composition of claim 1, wherein the anthraquinone concentration is from 0.001% to 5% by weight.

10. The bird repellent composition of claim 1, wherein the d-pulegone concentration is from 0.001% to 2% by weight.

11. A bait comprising the bird repellent composition of claim 1.

12. The bait of claim 11, wherein the bird repellent composition is applied to the bait surface.

13. The bait of claim 11, wherein the bait comprises a base bait material, wherein the base bait material is selected from the group consisting of a cereal, a carrot and a dough.

14. The bait of claim 11, wherein the bait is for attracting a pest animal.

15. The bait of claim 11, wherein the pest animal is a possum or a rat.

16. A method of repelling birds from an environment or object comprising the steps of:
selecting an environment or an object to which the repellent is to be applied; and
applying the repellent composition of claim 1 to the environment or object.

17. The method of claim 16, wherein the repellent composition is in a form selected from the group consisting of a liquid spray, a liquid dip, a gel, a paste and a solid powder.

18. The method of claim 16, wherein the repellent is applied to the environment or object by means selected from the group consisting of dipping, spraying, dusting and combinations thereof.

19. A method of repelling birds from a bait comprising applying the bird repellent composition of claim 1 to the bait.

20. The method of claim 19, wherein the repellent composition is in a form selected from the group consisting of a liquid spray, a liquid dip, a gel, a paste and a solid powder,

21. The method of claim 19, wherein the repellent is applied to the bait by a means selected from the group consisting of dipping, spraying, dusting and combinations thereof.
